(19) United States
(12) Patent Application Publication
(10) Pub. No.: US 2022/0022022 A1
(43) Pub. Date: Jan. 20, 2022

(54) DEVICE DISCOVERY METHOD AND APPARATUS, CONTROL TERMINAL, AND INTERNET OF THINGS AUXILIARY DEVICE

(71) Applicant: GUANGDONG OPPO MOBILE TELECOMMUNICATIONS CORP., LTD., Dongguan (CN)

(72) Inventor: Hai TANG, Dongguan (CN)

(73) Assignee: GUANGDONG OPPO MOBILE TELECOMMUNICATIONS CORP., LTD., Dongguan (CN)

(21) Appl. No.: 17/489,238

(22) Filed: Sep. 29, 2021

Related U.S. Application Data
(63) Continuation of application No. PCT/CN2019/080405, filed on Mar. 29, 2019.

(51) Int. Cl. H04W 8/00; H04W 60/00; H04L 29/08; G16Y 40/10

(52) U.S. Cl. CPC H04W 8/005; G16Y 40/10; H04L 67/12; H04W 60/00

(57) ABSTRACT

Embodiments of the present application provide a device discovery method and apparatus, a control terminal, and an Internet of Things auxiliary device, which relate to the field of communications over Internet of Things. The method is applied to an Internet of Things auxiliary device connected to a non-Internet-of-Things device, and the method includes: receiving a device discovery message transmitted by a control terminal; and transmitting a device discovery response message to the control terminal, where the device discovery response message includes a first device type and a second device type, the first device type is a device type of the Internet of Things auxiliary device, and the second device type is a device type of an Internet of Things device corresponding to the non-Internet-of-Things device.

### CROSS-REFERENCE TO RELATED APPLICATIONS

This application is a continuation of International Application No. PCT/CN2019/080405, filed on Mar. 29, 2019, the disclosure of which is hereby incorporated by reference in its entirety.

### TECHNICAL FIELD

Embodiments of the present application relate to the field of communications over Internet of Things and, in particular, to a device discovery method and apparatus, a control terminal, and an Internet of Things auxiliary device.

### BACKGROUND

With continuous development of Internet of Things (Internet of Things, IoT) technologies, more and more Internet of Things devices have emerged, such as smart air purifiers, smart rice cookers, smart table lamps, and so on.

In order to enable some non-Internet-of-Things devices that do not have Internet of Things functions to be able to access Internet of Things, in related technologies, the non-Internet-of-Things devices are generally connected to Internet of Things auxiliary devices having the Internet of Things functions, and a control terminal is used to control the Internet of Things auxiliary devices, so that indirect control of the non-Internet-of-Things devices is achieved with the aid of the Internet of Things auxiliary devices. For example, upon a connection to a conventional table lamp, a smart switch can be powered on or off under control of a mobile phone, thereby controlling the conventional table lamp to turn on or off.

Before controlling the Internet of Things auxiliary device, the control terminal first needs to discover the Internet of Things device through a device discovery function, and then transmits a corresponding control instruction to the Internet of Things auxiliary device over Internet.

### SUMMARY

Embodiments of the present application provide a device discovery method and apparatus, a control terminal, and an Internet of Things auxiliary device. The technical solution is as follows.

In one aspect, an embodiment of the present application provides a device discovery method applied to an Internet of Things auxiliary device connected to a non-Internet-of-Things device, including:

receiving a device discovery message transmitted by a control terminal; and

transmitting a device discovery response message to the control terminal, where the device discovery response message includes a first device type and a second device type, the first device type is a device type of the Internet of Things auxiliary device and the second device type is a device type of an Internet of Things device corresponding to the non-Internet-of-Things device.

In another aspect, an embodiment of the present application provides a device discovery method applied to a control terminal, including:

transmitting a device discovery message; and

receiving a device discovery response message transmitted by an Internet of things auxiliary device, where the device discovery response message includes a first device type and a second device type, the Internet of Things auxiliary device is connected to a non-Internet-of-Things device, the first device type is a device type of the Internet of Things auxiliary device, and the second device type is a device type of an Internet of Things device corresponding to the non-Internet-of-Things device.

In another aspect, an embodiment of the present application provides a device discovery apparatus applied to an Internet of Things auxiliary device connected to a non-Internet-of-Things device, including:

a first receiving module, configured to receive a device discovery message transmitted by a control terminal; and

a first transmitting module, configured to transmit a device discovery response message to the control terminal, where the device discovery response message includes a first device type and a second device type, the first device type is a device type of the Internet of Things auxiliary device, and the second device type is a device type of an Internet of Things device corresponding to the non-Internet-of-Things device.

In another aspect, an embodiment of the present application provides a device discovery apparatus applied to a control terminal, including:

a fifth transmitting module, configured to transmit a device discovery message; and

a fifth receiving module, configured to receive a device discovery response message transmitted by an Internet of Things auxiliary device, where the device discovery response message includes a first device type and a second device type, the Internet of Things auxiliary device is connected to a non-Internet-of-Things device, the first device type is a device type of the Internet of Things auxiliary device, and the second device type is a device type of an Internet of Things device corresponding to the non-Internet-of-Things device.

In another aspect, an embodiment of the present application provides an Internet of Things auxiliary device, including: a processor, a receiver, and a transmitter;

where the processor is configured to control the receiver to receive a device discovery message transmitted by a control terminal; and

the processor is configured to control the transmitter to transmit a device discovery response message to the control terminal, the device discovery response message includes a first device type and a second device type, the first device type is a device type of the Internet of Things auxiliary device, the second device type is a device type of an Internet of Things device corresponding to a non-Internet-of-Things device, and the Internet of Things auxiliary device is connected to the non-Internet-of-Things device.

In another aspect, an embodiment of the present application provides a control terminal, including: a processor, a receiver, and a transmitter;

where the processor is configured to control the transmitter to transmit a device discovery message; and

the processor is configured to control the receiver to receive a device discovery response message transmitted by an Internet of Things auxiliary device, the device discovery response message includes a first device type and a second device type, the Internet of Things auxiliary device is connected to a non-Internet-of-Things device, the first device type is a device type of the Internet of Things auxiliary device, and the second device type is a device type of an Internet of Things device corresponding to the non-Internet-of-Things device.

In another aspect, an embodiment of the present application provides an Internet of Things system, including: a control terminal, an Internet of Things auxiliary device and a non-Internet-of-Things device, where the Internet of Things auxiliary device is connected to the non-Internet-of-Things device;

the control terminal includes the control terminal according to the aspect described above; and

the Internet of Things auxiliary device includes the Internet of Things auxiliary device according to the aspect described above.

In another aspect, an embodiment of the present application provides a computer-readable storage medium storing at least one instruction which is executed by a processor to implement the device discovery method according to the aspect described above.

The technical solutions provided in the embodiments of the present application include at least the following beneficial effects:

since an Internet of Things auxiliary device has, stored therein, both a first device type of an Internet of Things auxiliary device and a second device type of a non-Internet-of-Things device connected to the Internet of Things auxiliary device, it, after receiving a device discovery message transmitted by a control terminal, can feedback the first device type and the second device type to the control terminal. Compared with the related art in which a control terminal can only discover an Internet of Things auxiliary device but fail to discover a non-Internet-of-Things device connected thereto, use of the solution provided in the embodiments of the present application enables the control terminal to discover a non-Internet-of-Things device in an Internet of Things system, which is conducive to improving efficiency of subsequent control on the non-Internet-of-Things device.

### BRIEF DESCRIPTION OF DRAWINGS

To illustrate the technical solutions in the embodiments of the present application more clearly, the drawings used for describing the embodiments will be briefly introduced below. Obviously, the accompanying drawings described below are only some embodiments of the present application. For persons of ordinary skilled in the art, other drawings may also be derived from these drawings without any creative effort.

FIG. 1 is a schematic structural diagram of an Internet of Things system provided in an exemplary embodiment of the present application;

FIG. 2 shows a flowchart of a device discovery method provided in an exemplary embodiment of the present application;

FIG. 3 is a schematic diagram of an interface of an implementation process of the device discovery method shown in FIG. 2;

FIG. 4 is a flowchart of a registration process of a non-Internet-of-Things device provided in an embodiment;

FIG. 5 is a schematic diagram of an interface of a registration process shown in FIG. 4;

FIG. 6 is a flowchart of a registration process of a non-Internet-of-Things device provided in another embodiment;

FIG. 7 shows a schematic structural diagram of a device discovery apparatus provided in an embodiment of the present application;

FIG. 8 shows a schematic structural diagram of a device discovery apparatus provided in another embodiment of the present application;

FIG. 9 shows a schematic structural diagram of an Internet of Things auxiliary device provided in an exemplary embodiment of the present application; and

FIG. 10 shows a schematic structural diagram of a control terminal provided in an exemplary embodiment of the present application.

### DESCRIPTION OF EMBODIMENTS

The words such as “first”, “second” and the like, as mentioned herein, are not intended to indicate any order, quantity, or importance, but are only used to distinguish different components. Similarly, the words such as “a” or “an” and the like do not indicate a quantity limitation, but indicate that there is at least one. The words such as “connect” or “connected” and the like are not limited to physical or mechanical connections, but may include electrical connections, either direct or indirect.

The “module” as mentioned herein generally refers to a program or an instruction stored in a memory and capable of performing certain functions; and the “unit” as mentioned herein generally refers to a logically divided functional structure, and the “unit” can be implemented by only hardware or a combination of hardware and software.

The “multiple” as mentioned herein means two or more than two. The “and/or” describes an association relationship between associated objects, which indicates that there may be three relationships. For example, A and/or B may indicate presence of A only, of both A and B, and of B only. The character “/” generally indicates that there is an “or” relationship between contextual objects.

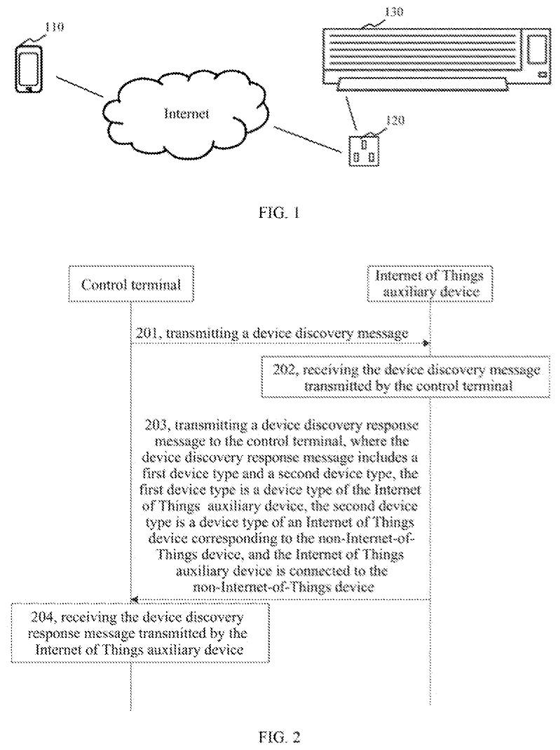

Please refer to FIG. 1 which shows a schematic structural diagram of an Internet of Things system provided in an exemplary embodiment of the present application. The Internet of Things system includes a control terminal 110, an Internet of Things auxiliary device 120, and a non-Internet-of-Things device 130.

The control terminal 110 is an electronic device with an Internet access function, which may be a smart phone, a tablet computer, a wearable smart device, a personal computer, etc. As shown in FIG. 1, the control terminal 110 is a smart phone.

Optionally, an Internet of Things application is installed in the control terminal 110, through which the control terminal 110 can control an Internet of Things device or view operation data of the Internet of Things device.

The Internet of Things auxiliary device 120 is a device with an Internet of Things function, which can receive, over the Internet, a control instruction transmitted by the control terminal 110 and feedback current operation data to the control terminal 110 over the Internet. The Internet of Things auxiliary device 120 may be a smart socket, a smart remote controller, etc., and the Internet of Things auxiliary device 120 is not limited in the embodiments of the present application with regard to its specific type.

The Internet of Things auxiliary device 120 in the embodiments of the present application is used to connect the non-Internet-of-Things device 130 to the Internet of Things system, so that the control terminal 110 can control the Internet of Things auxiliary device 120 to achieve indirect control of the non-Internet-of-Things device 130.

Optionally, the non-Internet-of-Things device 130 may be an electronic device without a network connection function, such as a conventional air conditioner, refrigerator, washing machine, air purifier, or table lamp. The non-Internet-of-Things device 130 is not limited in the embodiments of the present application with regard to its specific type.

Optionally, the Internet of Things auxiliary device 120 is electrically connected to the non-Internet-of-Things device 130. For example, as shown in FIG. 1, the non-Internet-of-Things device 130 is a conventional air conditioner while the Internet of Things auxiliary device 120 is a smart socket, and the conventional air conditioner has its plug electrically connected to the smart socket.

Optionally, the Internet of Things auxiliary device 120 is connected to the non-Internet-of-Things device 130 through a wireless connection (a continuous connection or a non-continuous connection), and the wireless connection may be a Bluetooth connection, an infrared connection, an NFC connection, etc. For example, the non-Internet-of-Things device 130 is a conventional air conditioner while the Internet of Things auxiliary device 120 is a smart remote controller, and the smart remote controller is connected to the conventional air conditioner through infrared rays.

Certainly, the Internet of Things system may also contain a smart air purifier, a smart TV, a smart speaker, a smart refrigerator and other Internet of Things devices, which is not limited in the embodiments of the present application.

In the related art, an Internet of Things auxiliary device has its own device information stored in a resource discovery list; upon receiving a device discovery message transmitted by a control terminal, the Internet of Things auxiliary device will feedback its own device information to the control terminal so that the control terminal controls it after discovering the Internet of Things auxiliary device. However, the control terminal can only display a discovered Internet of Things auxiliary device according to the device information that is fed back, but cannot further know information of a non-Internet-of-Things device that is connected to the Internet of Things auxiliary device, rendering that the non-Internet-of-Things device is free from the Internet of Things system and does not have the ability to be discovered by the control terminal.

Moreover, since the control terminal can only display the Internet of Things auxiliary device that has been discovered, when a user wants to control the non-Internet-of-Things device, it first needs to determine the Internet of Things auxiliary device connected to the non-Internet-of-Things device, and then transmit a corresponding control instruction to the Internet of Things auxiliary device. When the Internet of Things system contains multiple Internet of Things auxiliary devices, it is difficult to determine a respective Internet of Things auxiliary device corresponding to each non-Internet-of-Things device, thereby affecting efficiency of the user's control of the non-Internet-of-Things device.

Although the user can quickly determine an Internet of Things auxiliary device corresponding to a non-Internet-of-Things device by modifying the name of the Internet of Things auxiliary device (for example, modifying a name of the smart switch connected to the conventional air conditioner to an air conditioner), it is inefficient when the Internet of Things auxiliary device is controlled by multiple control terminals simultaneously, each control terminal needs to manually modify the name of the Internet of Things auxiliary device.

In the device discovery method provided in the embodiment of the present application, an Internet of Things auxiliary device has, stored in its resource discovery list, both a first device type of the Internet of Things auxiliary device and a second device type of a non-Internet-of-Things device connected to the Internet of Things auxiliary device. Therefore, after receiving a device discovery message transmitted by a control terminal, the Internet of Things auxiliary device can feedback both the first device type and the second device type to the control terminal. Correspondingly, the control terminal can display both the Internet of Things auxiliary device and the non-Internet-of-Things device according to the first device type and the second device type, which realizes discovery of the non-Internet-of-Things device in the Internet of Things system and is conducive to improving efficiency of a user's control of the non-Internet-of-Things device. Description will be made hereunder with illustrative embodiments.

Please refer to FIG. 2 which shows a flowchart of a device discovery method provided in an exemplary embodiment of the present application. The method is used in the implementation environment shown in FIG. 1. The method includes the following steps.

Step 201: a control terminal transmits a device discovery message.

In a possible implementation, the control terminal transmits a device discovery message in a multicast manner, and an Internet of Things device and an Internet of Things auxiliary device within the multicast range receive the device discovery message.

Optionally, when the device discovery message is used to discover all Internet of Things devices and Internet of Things auxiliary devices within the multicast range, the device discovery message does not contain a query condition; and when the device discovery message is used to discover an Internet of Things device and an Internet of Things auxiliary device of a specified device type within the multicast range, the device discovery message contains a query condition where a target device type is contained.

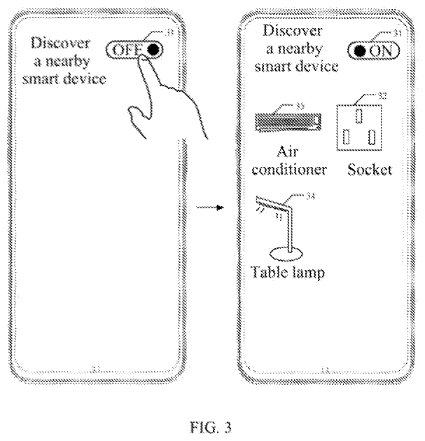

As shown in FIG. 3, when a click operation on a device discovery control 31 in an Internet of Things management application is received, the control terminal transmits the device discovery message.

Step 202: an Internet of Things auxiliary device receives the device discovery message transmitted by the control terminal.

Where the Internet of Things auxiliary device within the multicast range receives the device discovery message, while the non-Internet-of-Things device connected to the Internet of Things auxiliary device cannot receive the device discovery message.

Step 203: the Internet of Things auxiliary device transmits a device discovery response message to the control terminal, where the device discovery response message includes a first device type and a second device type, the first device type is a device type of the Internet of Things auxiliary device, the second device type is a device type of an Internet of Things device corresponding to the non-Internet-of-Things device, and the Internet of Things auxiliary device is connected to the non-Internet-of-Things device.

Optionally, the Internet of Things auxiliary device acquires device information from a resource discovery list, and adds the device information to the device discovery response message.

Where information in the resource discovery list (/res) is used for device discovery, that is, the information in the resource discovery list is used to be provided to the control terminal that transmits the device discovery message, so that the control terminal displays the discovered device according to the received information.

Optionally, the resource discovery list includes at least the first device type and the second device type, and may also include other information such as operation function sets, interface types, device identifiers, and port information of the devices.

Different from the related art in which the Internet of Things auxiliary device only has its own device type (that is, the first device type) contained in the resource discovery list, the Internet of Things auxiliary device in the embodiment of the present application also has, the device type of the non-Internet-of-Things device connected thereto, contained in the resource discovery list. Correspondingly, after receiving the device discovery message, the Internet of Things auxiliary device feeds back both the first device type and the second device type to the control terminal, so that the control terminal can discover both the Internet of Things auxiliary device and the non-Internet-of-Things device.

Certainly, in addition to feeding back the first device type and the second device type, the Internet of Things auxiliary device may also feedback other device information, which is not limited in this embodiment.

Illustratively, in the implementation environment shown in FIG. 1, the information fed back by the Internet of Things auxiliary device 120 to the control terminal 110 contains the first device type oic.d.switch (a smart switch) and the second device type oic.d.airconditioner (an air conditioner).

Step 204: the control terminal receives the device discovery response message transmitted by the Internet of Things auxiliary device.

In a possible implementation, the control terminal displays a first device identifier corresponding to the Internet of Things auxiliary device and a second device identifier corresponding to the non-Internet-of-Things device according to the first device type and the second device type that are received.

Illustratively, as shown in FIG. 3, the control terminal displays, in the Internet of Things management application, a first icon 32 corresponding to the smart switch, a second icon 33 corresponding to the air conditioner, and a third icon 34 corresponding to the table lamp according to the received device discovery response.

It should be noted that the control terminal may further configure the discovered device to access to the network, so that the device that accesses to the network can be subsequently controlled over the Internet, and details for which will not be described repetitively in this embodiment.

To sum up, in the embodiment of the present application, since an Internet of Things auxiliary device has, stored therein, both a first device type of an Internet of Things auxiliary device and a second device type of a non-Internet-of-Things device connected to the Internet of Things auxiliary device, it can feedback the first device type and the second device type to the control terminal, after receiving the device discovery message transmitted by the control terminal. Compared with the related art in which a control terminal can only discover an Internet of Things auxiliary device but fail to discover a non-Internet-of-Things device connected thereto, use of the solution provided in the embodiments of the present application enables a control terminal to discover a non-Internet-of-Things device in an Internet of Things system, which is conducive to improving efficiency of subsequent control on the non-Internet-of-Things device.

It should be noted that, in the above embodiment, steps in which the control terminal is an executive subject may be separately implemented as a device discovery method on a control terminal side, and steps in which the Internet of Things auxiliary device is an executive subject may be separately implemented as a device discovery method on an Internet of Things auxiliary device side, and details for which will not be described repetitively in this embodiment.

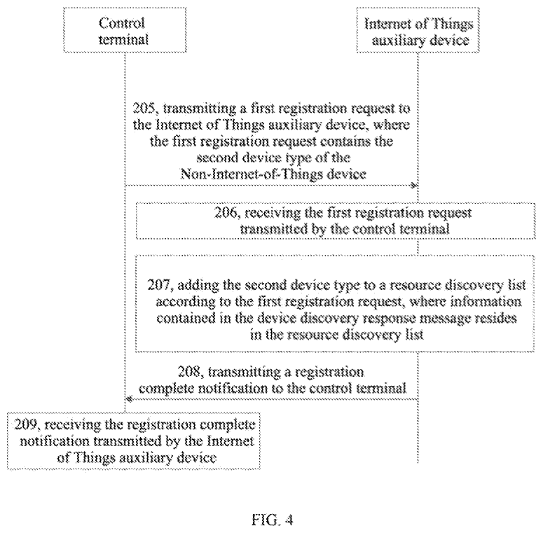

Since an Internet of Things auxiliary device may be connected to different non-Internet-of-Things devices (for example, a smart switch may be connected to a conventional air conditioner, and may also be connected to a conventional refrigerator), and the Internet of Things auxiliary device cannot initiatively acquire device types of the non-Internet-of-Things devices. Therefore, in a possible implementation, a control terminal transmits a registration request to an Internet of Things auxiliary device to instruct the Internet of Things auxiliary device to add a device type of a non-Internet-of-Things device to its resource discovery list. As shown in FIG. 4, the following steps are also included before Step 201.

Step 205: the control terminal transmits a first registration request to the Internet of Things auxiliary device, where the first registration request contains the second device type of the Non-Internet-of-Things device.

In order to enable the Non-Internet-of-Things device connected to the Internet of Things auxiliary device to be discovered by each control terminal, in a possible implementation, after the Internet of Things auxiliary device is configured (that is, it has been connected to the network), the control terminal transmits a first registration request to the Internet of Things auxiliary device to instruct the Internet of Things auxiliary device to register the connected Non-Internet-of-Things device, where the first registration request can be transmitted over the Internet.

Optionally, the second device type of the Non-Internet-of-Things device is specified by the user through the control terminal.

Illustratively, as shown in FIG. 5, when a Non-Internet-of-Things device needs to be registered, the user selects an Internet of Things auxiliary device connected to the Non-Internet-of-Things device and clicks a device registration button 51, and the control terminal displays several types of Non-Internet-of-Things devices for user selection. Upon receiving a click operation on an option 52 corresponding to “air conditioner”, the control terminal transmits a first registration request to the Internet of Things auxiliary device, where the first registration request contains a device type corresponding to “air conditioner”: oic.d.airconditioner.

Step 206: the Internet of Things auxiliary device receives the first registration request transmitted by the control terminal.

Optionally, the Internet of Things auxiliary device receives the first registration request transmitted by the control terminal over the Internet, and acquires the second device type contained in the first registration request.

Step 207: the Internet of Things auxiliary device adds the second device type to a resource discovery list according to the first registration request, where information contained in the device discovery response message resides in the resource discovery list.

In a possible implementation, the Internet of Things auxiliary device creates an Internet of Things device corresponding to the Non-Internet-of-Things device (the device type is the second device type) according to the first registration request, and adds the Internet of Things device to a device list of the Internet of Things auxiliary device, and then updates the resource discovery list based on the device list.

Optionally, this step includes the following, steps.

I. Adding the second device type to the device list of the Internet of Things auxiliary device, where the device list contains first device information of the Internet of Things auxiliary device.

Device information is stored under the device list (/d), and the device information includes at least one of a device type, a device identifier, an interface type, an operation function set, and port information. Before registration, the device list of the Internet of Things auxiliary device only contains the device information of the Internet of Things auxiliary device.

Optionally, after receiving the first registration request, the Internet of Things auxiliary device creates a second device type of Internet of Things device based on the second device type and the device information of the Internet of Things auxiliary device, and adds the second device type to the device list.

An example is taken where the Internet of Things auxiliary device has a first device type of oic.d.switch and its original device list (/d) is stored with rt: oic.d.switch (indicating that the device type is a switch). When the received first registration request contains a second device type of oic.d.airconditioner, the Internet of Things auxiliary device adds rt: oic.d.airconditioner under /d.

II. Updating the resource discovery list based on the device list, where the resource discovery list contains the device list.

The resource discovery list (/res) contains all resource information that the Internet of Things auxiliary device expects to be discovered by the control terminal, and the device list is contained in the resource discovery list. Therefore, after the second device type is added to the device list, the Internet of Things auxiliary device needs to update its own resource discovery list so that the updated resource discovery list contains the device information of the Internet of Things device.

Step 208: the Internet of Things auxiliary device transmits a registration complete notification to the control terminal.

The Internet of Things auxiliary device transmits a registration complete notification to the control terminal after completing the registration of the Non-Internet-of-Things device.

Step 209: the control terminal receives the registration complete notification transmitted by the Internet of Things auxiliary device.

Optionally, after receiving the registration complete notification transmitted by the Internet of Things auxiliary device, the control terminal displays a registration succeed prompt to inform the user that the Non-Internet-of-Things device has been added.

Optionally, after the registration is completed through the above steps, when receiving the device discovery message transmitted by the control device, the Internet of Things auxiliary device queries the device list (/d) under the resource discovery list (/res) and feeds back oic.d.switch and oic.d.airconditioner contained in the attribute rt to the control terminal.

Regarding the process of adding the second device type to the device list in the foregoing embodiment, in a possible implementation, the process may include the following steps.

I. Generating second device information of the Non-Internet-of-Things device, where the second device information includes at least one of a device identifier, a device type, an interface type, an operation function set, and port information.

In a possible implementation, the Internet of Things auxiliary device generates, according to the second device type of the Non-Internet-of-Things device and its own first device information, the second device information of the Non-Internet-of-Things device. This step may include the following sub-steps.

1. Generating a device identifier of the Non-Internet-of-Things device, where the device identifier of the Non-Internet-of-Things device is different from the device identifier of the Internet of Things auxiliary device.

In this embodiment, since the Non-Internet-of-Things device appears as a (virtual) Internet of Things device in the Internet of Things, the Internet of Things auxiliary device needs to configure a device identifier for the Non-Internet-of-Things device.

Where the device identifier of the Non-Internet-of-Things device is different from the device identifier of the Internet of Things auxiliary device, and is unique, that is, it is different from device identifiers of other devices in the Internet of Things system.

2. Generating an interface type of the Non-Internet-of-Things device, where the interface type is used to indicate an access mode of a device interface, and the interface type of the Non-Internet-of-Things device is identical to an interface type of the Internet of Things auxiliary device.

Where different types of device interfaces have different interface access modes. For example, for a device interface with an interface type of oic.if.rw, the control terminal may perform a read/write operation through the device interface; for a device interface with an interface type of oic.if.baseline, the control terminal may acquire all attributes of the device through the device interface; and for a device interface with an interface type of oic.if.a, the control terminal may obtain a non-general attribute of the device through the device interface, such as a switching state of a smart switch. For a specific interface type, it is not limited in the embodiment of the present application.

Although the Non-Internet-of-Things device appears as an Internet of Things device, its Internet of Things function is actually achieved with the aid of the Internet of Things auxiliary device. Therefore, the Non-Internet-of-Things device needs to inherit the interface type of the Internet of Things auxiliary device.

Certainly, in other possible implementations, the number of interlace types of the Non-Internet-of-Things device may also be less than the number of interface types of the Internet of Things auxiliary device.

3. Generating an operation function set of the Non-Internet-of-Things device, where the operation function set is a set of device support functions, and the operation function set of the Non-Internet-of-Things device is identical to an operation function set of the Internet of Things auxiliary device, or, the operation function set of the Non-Internet-of-Things device is a subset of the operation function set of the Internet of Things auxiliary device.

Where different types of Internet of Things smart devices have different corresponding operation function sets. For example, for a smart switch, its corresponding operation function set can be expressed as oic.r.switchbinary, and the smart switch can be controlled by means of setting the value of oic.r.switchbinary to be “true” or “false”.

Since the functions presented by the Non-Internet-of-Things device are functions of the connected Internet of Things auxiliary device, the Non-Internet-of-Things device needs to inherit the operation function set of the Internet of Things auxiliary device.

Certainly, in other possible implementations, the number of functions in the operation function set of the Non-Internet-of-Things device may also be less than the number of functions in the operation function set of the Internet of Things auxiliary device, that is, the Non-Internet-of-Things device only presents part of the functions of the Internet of Things auxiliary device (a subset of the operation function set of the Internet of Things auxiliary device).

4. Generating port information of the Non-Internet-of-Things device, where the port information of the Non-Internet-of-Things device is identical to or different from port information of the Internet of Things auxiliary device.

Optionally, the port information includes an IP address and a port number (port). The Internet of Things auxiliary device can set different port information for the Non-Internet-of-Things device by modifying the port number.

In a possible implementation, the Non-Internet-of-Things device and the Internet of Things auxiliary device have the same IP address, but have different port numbers. For example, the Non-Internet-of-Things device and the Internet of Things auxiliary device both have an IP address of 49.66.110.33, while the Internet of Things auxiliary device has a port number of 8010 and the non-Internet-of-Things device has a port number of 8011.

In an illustrative example, the device information of the Internet of Things auxiliary device (such as a smart switch) and the Non-Internet-of-Things device (such as an air conditioner) is shown in Table 1.

TABLE 1

| | Internet of Things | Non-Internet-of-Things |
|---|---|---|
| | auxiliary device | device |
| Device identifier | UID123456 | UID123457 |
| Interface type | oic.if.baseline | oic.if.baseline |
| Operation function set | oic.r.switchbinary | oic.r.switchbinary |
| Port information | 49.66.110.3: 8010 | 49.66.110.3: 8011 |
| Device type | oic.d.switch | oic.d.airconditioner |

II. Adding the second device information to the device list of the Internet of Things auxiliary device.

After generating the second device information of the Non-Internet-of-Things device, the Internet of Things auxiliary device completes the creation of the Internet of Things device corresponding to the Non-Internet-of-Things device, thereby adding the second device information to the device list (/d) of the Internet of Things auxiliary device.

After the second device type is added to the device list using the method provided in the above embodiment, the Internet of Things auxiliary device feeds back the first device information and the second device information to the control terminal according to the device discovery message, and then the control terminal displays the Internet of Things auxiliary device and the Non-Internet-of-Things device according to the first device infornation and the second device information. When the user controls the Non-Internet-of-Things device subsequently, the control terminal transmits a control instruction (essentially to the Internet of Things auxiliary device) according to the port information in the second device information, thereby achieving the control of the Non-Internet-of-Things device.

It should be noted that when receiving a device discovery message for discovering: a specified type of device transmitted by the control terminal, the Internet of Things auxiliary device detects whether the first device type and the second device type match the specified device type, and feeds back device information matching the specified device type to the control terminal. Details will not be described repetitively in this embodiment.

Regarding the process of adding the second device type to the device list in the above embodiment, in another possible implementation, the process may include the following steps.

I. Determining the first device information of the Internet of Things auxiliary device as device information of the Non-Internet-of-Things device.

Different from that the separate resource is allocated to the non-smart device in the above embodiment, the non-smart device in this embodiment uses the resource of the Internet of Things auxiliary device.

Optionally, the Internet of Things auxiliary device determines its own interface type as an interface type of the Non-Internet-of-Things device; determines its own operation function set as an operation function set of the Non-Internet-of-Things device; and determines its own port information as port information of the Non-Internet-of-Things device.

It should be noted that the Internet of Things auxiliary device and the Non-Internet-of-Things device have different device types.

II. Adding a target parameter to the device list of the Internet of Things auxiliary device, where the target parameter contains the second device type, and the target parameter is used to indicate that the Internet of Things auxiliary device is connected to the Non-Internet-of-Things device.

Different from that the first device type is added to the original parameter type in the above embodiment, in this embodiment, by adding a new parameter to the device list, the device type of the Non-Internet-of-Things device connected to the Internet of Things auxiliary device is indicated through the new parameter.

In a possible implementation, the device list of the Internet of Things auxiliary device originally contains a parameter of rt: oic.d.switch, in order to enable the control device to know the controlled Non-Internet-of-Things device according to the response of the Internet of Things auxiliary device, the Internet of Things auxiliary device adds a target parameter of rt-d: oic.d.airconditioner to the device list.

After the registration is completed through this method, for the device discovery process, optionally, when the device discovery message transmitted by the control device is received and the device discovery message does not contain a target device type (that is, for discovering all types of devices), the Internet of Things auxiliary device queries the device list (/d) under the resource discovery list (/res), and transmits a device discovery response message containing the first device type (rt: oic.d.switch) and the target parameter (rt-d: oic.d.airconditioner) to the control terminal. After receiving the device discovery response message fed back by the Internet of Things auxiliary device, the control terminal can know, according to the target parameter, that the Internet of Things auxiliary device is connected to the Non-Internet-or-Things device, so that both the Internet of Things auxiliary device and the Non-Internet-of-Things device are displayed, thereby improving the efficiency of subsequent control of the Non-Internet-of-Things device.

Optionally, when the device discovery message transmitted by the control device is received and the device discovery message contains a target device type (that is, for discovering a specified type of device), the Internet of Things auxiliary device queries the device list (/d) under the resource discovery list (/res). If the first device type matches the target device type (that is, a device type that matches the target device type is contained under rt), and/or, the second device type contained in the target parameter matches the target device type (that is, a device type that matches the target device type is contained under rt-d), the Internet of Things auxiliary device responds to the device discovery message; otherwise, the Internet of Things auxiliary device will not respond.

In an illustrative example, when the device discovery message contains a target device type of oic.d.airconditioner, the Internet of Things auxiliary device queries that rt: oic.d.switch and rt-d: oic.d.airconditioner are contained under /d in /res, thus rt-d: oic.d.airconditioner is fed back to the control terminal so that the control terminal can discover the Non-Internet-of-Things device “air conditioner” in the Internet of Things system. Since the device information of the Non-Internet-of-Things device “air conditioner” uses the device information of the Internet of Things auxiliary device “switch”, the control instruction transmitted by the control terminal to the Non-Internet-of-Things device “air conditioner” is transmitted to the Internet of Things auxiliary device “switch” subsequently, thereby achieving indirect control of the Non-Internet-of-Things device “air conditioner” with the aid of the Internet of Things auxiliary device “switch”.

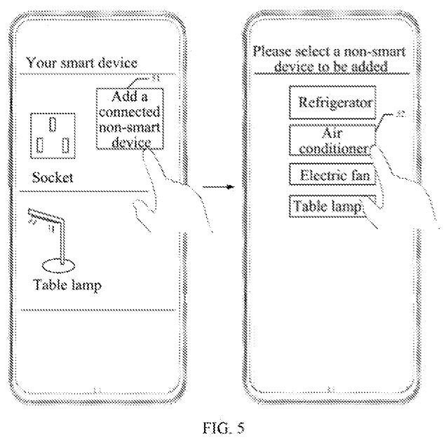

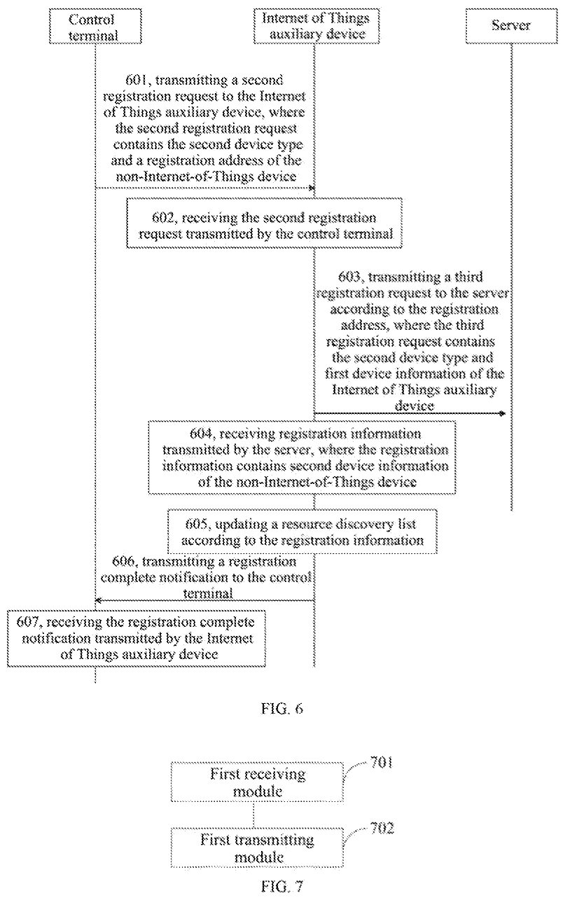

In the above embodiments, the non-Internet-of-Things device is registered by the Internet of Things auxiliary device. In other possible implementations, the Internet of Things auxiliary device may also perform a registration with the aid of a cloud server. As shown in FIG. 6, the registration process may include the following steps.

Step 601: the control terminal transmits a second registration request to the Internet of Things auxiliary device, where the second registration request contains the second device type and a registration address of the non-Internet-of-Things device.

Different from the first registration request in the above embodiment, in addition to the second device type, the second registration request also includes a registration address for a server. For example, the registration address is the server's IP address+port number.

Step 602: the Internet of Things auxiliary device receives the second registration request transmitted by the control terminal.

Step 603: the Internet of Things auxiliary device transmits a third registration request to the server according to the registration address, where the third registration request contains the second device type and first device information of the Internet of Things auxiliary device.

In this embodiment, after receiving the second registration request, the Internet of Things auxiliary device completes the registration of the Non-Internet-of-Things device with the aid of the server, and transmits the second device type and the first device information of the Internet of Things auxiliary device in itself to the server.

Optionally, after receiving the third registration request, the server generates second device information of the non-Internet-of-Things device according to the second device type and the first device information. Where the second device information contains at least one of a device identifier, a device type, an interface type, an operation function set, and port information. Illustratively, the generated second device information is as shown in Table 1 in the above embodiment.

Step 604: the Internet of Things auxiliary device receives registration information transmitted by the server, where the registration information contains second device information of the non-Internet-of-Things device.

The server transmits the generated registration information to the Internet of Things auxiliary device so that the Internet of Things auxiliary device completes the registration of the non-Internet-of-Things device.

Step 605: the Internet of Things auxiliary device updates a resource discovery list according to the registration information.

In a possible implementation, the Internet. of Things auxiliary device adds the registration information to its own device list, and updates a resource discovery list based on the device list, that is, the updated resource discovery list contains the device information of the non-Internet-of-Things device.

Step 606: the Internet of Things auxiliary device transmits a registration complete notification to the control terminal.

Step 607: the control terminal receives the registration complete notification transmitted by the Internet of Things auxiliary device.

For implementations of Steps 606 to 607, reference may be made to Steps 208 to 209 described above, and details will not be described herein again in this embodiment,

In addition to achieving the registration with the aid of the server, the Internet of Things auxiliary device may also transmit a third registration request to the control terminal, and the control terminal feeds back the generated registration information to the Internet of Things auxiliary device, which is not limited in the embodiment of the present application.

The following are apparatus embodiments of the embodiments of the present application. For the parts that are not described in detail in the apparatus embodiments, reference may be made to the technical details disclosed in the above method embodiments.

Please refer to FIG. 7 which shows a schematic structural diagram of a device discovery apparatus provided by an embodiment of the present application. The device discovery apparatus may be implemented as an entirety or a part of the Internet of Things auxiliary device through software, hardware and a combination thereof. The device discovery apparatus includes:

a first receiving module 701, configured to receive a device discovery message transmitted by a control terminal; and

a first transmitting module 702, configured to transmit a device discovery response message to the control terminal, where the device discovery response message includes a first device type and a second device type, the first device type is a device type of the Internet of Things auxiliary device, and the second device type is a device type of an Internet of Things device corresponding to the non-Internet-of-Things device.

Optionally, the apparatus includes:

a second receiving module, configured to receive a first registration request transmitted by the control terminal, where the first registration request contains the second device type of the non-Internet-of-Things device;

a registration module, configured to add the second device type to a resource discovery list according to the first registration request, where information contained in the device discovery response message resides in the resource discovery list; and

a second transmitting module, configured to transmit a registration complete notification to the control terminal.

Optionally, the registration module is configured to:

add the second device type to a device list of the Internet of Things auxiliary device, where the device list contains first device information of the Internet of Things auxiliary device; and

update the resource discovery list based on the device list, where the resource discovery list contains the device list.

Optionally, the registration module is further configured to:

generate second device information of the non-Internet-of-Things device, where the second device information includes at least one of a device identifier, a device type, an interface type, an operation function set and port information; and

add the second device information to the device list of the Internet of Things auxiliary device.

Optionally, the registration module is further configured to:

generate a device identifier of the non-Internet-of-Things device, where the device identifier of the non-Internet-of-Things device is different from the device identifier of the Internet of Things auxiliary device;

generate an interface type of the non-Internet-of-Things device, where the interface type is used to indicate an access mode of a device interface, and the interface type of the non-Internet-of-Things device is identical to an interface type of the Internet of Things auxiliary device;

generate an operation function set of the non-Internet-of-Things device, where the operation function set is a set of device support functions, and the operation function set of the non-Internet-of-Things device is identical to an operation function set of the Internet of Things auxiliary device; or, the operation function set of the non-Internet-of-Things device is a subset of the operation function set of the Internet of Things auxiliary device; and

generate port information of the non-Internet-of-Things device, where the port information of the non-Internet-of-Things device is identical to or different from port information of the Internet of Things auxiliary device.

Optionally, the registration module is further configured to:

determine the first device information of the Internet of Things auxiliary device as device information of the non-Internet-of-Things device; and

add a target parameter to the device list of the Internet of Things auxiliary device, where the target parameter contains the second device type, and the target parameter is used to indicate that the Internet of Things auxiliary device is connected to the non-Internet-of-Things device.

Optionally, the first transmitting module 702 is configured to:

if the device discovery message does not contain a target device type, transmit the device discovery response message containing the first device type and the target parameter to the control terminal.

Optionally, the device discovery message contains the target device type, and the apparatus further includes:

a response module, configured to respond to the device discovery message, if the first device type matches the target device type and/or the second device type contained in the target parameter matches the target device type.

Optionally, the apparatus further includes:

a third receiving module, configured to receive a second registration request transmitted by the control terminal, where the second registration request contains a registration address and the second device type;

a third transmitting module, configured to transmit a third registration request to a server according to the registration address, where the third registration request contains the second device type and first device information of the Internet of Things auxiliary device;

a fourth receiving module, configured to receive registration information transmitted by the server, where the registration information contains second device information of the non-Internet-of-Things device;

an updating module, configured to update the resource discovery list according to the registration information; and

a fourth transmitting module, configured to transmit a registration complete notification to the control terminal.

Please refer to FIG. 8 which shows a schematic structural diagram of a device discovery apparatus provided by an embodiment of the present application. The device discovery apparatus may be implemented as an entirety or a part of the control terminal through software, hardware and a combination thereof. The device discovery apparatus includes:

a fifth transmitting module 801, configured to transmit a device discovery message; and

a fifth receiving module 802, configured to receive a device discovery response message transmitted by an Internet of Things auxiliary device, where the device discovery response message includes a first device type and a second device type, the Internet of Things auxiliary device is connected to a non-Internet-of-Things device, the first device type is a device type of the Internet of Things auxiliary device, and the second device type is a device type of an Internet of Things device corresponding to the non-Internet-of-Things device.

Optionally, the apparatus further includes:

a sixth transmitting module, configured to transmit a first registration request to the Internet of Things auxiliary device, where the first registration request contains the second device type of the non-Internet-of-Things device; and

a sixth receiving module, configured to receive a registration complete notification transmitted by the Internet of Things auxiliary device.

Optionally, the apparatus further includes:

a seventh transmitting module, configured to transmit a second registration request to the Internet of Things auxiliary device, where the second registration request contains the second device type and a registration address of the non-Internet-of-Things device, and the Internet of Things auxiliary device is configured to transmit a third registration request to a server according to the registration address and acquire registration information; and

a seventh receiving module, configured to receive a registration complete notification transmitted by the Internet of Things auxiliary device.

Please refer to FIG. 9 which shows a schematic structural diagram of an Internet of Things auxiliary device provided by an exemplary embodiment of the present application. The Internet of Things auxiliary device includes: a processor 901, a receiver 902, a transmitter 903, a memory 904, and a bus 905.

The processor 901 includes one or more than one processing core, and executes various functions and information processing by running a software program and a module.

The receiver 902 and the transmitter 903 may be implemented as a communication component which may be a communication chip.

The memory 904 is connected to the processor 901 through the bus 905.

The memory 904 may be used to store at least one instruction; and the processor 901 is used to execute the at least one instruction to implement steps performed by the Internet of Things auxiliary device in the above method embodiment.

In addition, the memory 904 may be implemented by any type of volatile or non-volatile storage device, or a combination thereof. The volatile or non-volatile storage device includes, but is not limited to, a magnetic disk or an optical disk, an electrically erasable programmable read-only memory (EEPROM), an erasable programmable read-only memory (EPROM), a static random access memory (SRAM), a read-only memory (ROM), a magnetic memory, a flash memory, and a programmable read-only memory (PROM).

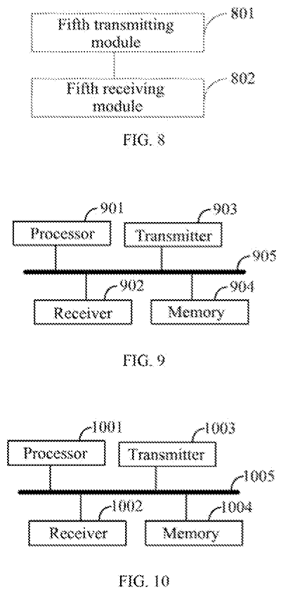

Please refer to FIG. 10 which shows a schematic structural diagram of a control terminal provided by an exemplary embodiment of the present application. The control terminal includes a processor 1001, a receiver 1002, a transmitter 1003, a memory 1004, and a bus 1005.

The processor 1001 includes one or more than one processing core, and executes various functions and information processing by running a software program and a module.

The receiver 1002 and the transmitter 1003 may be implemented as a communication component which may be a communication chip.

The memory 1004 is connected to the processor 1001 through the bus 1005.

The memory 1004 may be configured to store at least one instruction; and the processor 1001 is configured to execute the at least one instruction to implement steps performed by the control terminal in the above method embodiment.

In addition, the memory 1004 may be implemented by any type of volatile or non-volatile storage device, or a combination thereof. The volatile or non-volatile storage device includes, but is not limited to, a magnetic disk or art optical disk, an electrically erasable programmable read-only memory (EEPROM), an erasable programmable read-only memory (EPROM), a static random access memory (SRAM), a read-only memory (ROM), a magnetic memory, a flash memory, and a programmable read-only memory (PROM).

The present application provides a computer-readable storage medium storing at least one instruction which is loaded and executed by the processor to implement the device discovery method provided in the above each method embodiment.

The present application further provides a computer program product which, when running on a computer, causes the computer to execute the device discovery method provided in the above each method embodiment.

Those skilled in the art should be aware that in one or more of the above examples, the functions described in the embodiments of the present application may be implemented by hardware, software, firmware, or any combination thereof. When implemented by software, the functions may be stored in a computer readable medium or transmitted as one or more instructions or codes on the computer readable medium. The computer readable medium includes a computer storage medium and a communication medium, where the communication medium includes any medium that facilitates transfer of a computer program from one location to another location. The storage medium may be any available medium that can be accessed by a general-purpose or special-purpose computer.

The above descriptions are only preferred embodiments of the present application, but are not intended to limit the present application. Any modifications, equivalent replacements, improvements, etc., which are within the spirit and principle of the present application, should be included in the protection scope of the present application.

What is claimed is:

1. A device discovery method applied to an Internet of Things auxiliary device connected to a non-Internet-of-Things device, comprising:
receiving a device discovery message transmitted by a control terminal; and
transmitting a device discovery response message to the control terminal, wherein the device discovery response message comprises a first device type and a second device type, the first device type is a device type of the Internet of Things auxiliary device, and the second device type is a device type of an Internet of Things device corresponding to the non-Internet-of-Things device.

2. The method according to claim 1, wherein before receiving the device discovery message transmitted by the control terminal, the method comprises:
receiving a first registration request transmitted by the control terminal, wherein the first registration request contains the second device type of the non-Internet-of-Things device;
adding the second device type to a resource discovery list according to the first registration request, wherein information contained in the device discovery response message resides in the resource discovery list; and
transmitting a registration complete notification to the control terminal.

3. The method according to claim 2, wherein the adding the second device type to the resource discovery list comprises:
adding the second device type to a device list of the Internet of Things auxiliary device, wherein the device list contains first device information of the Internet of Things auxiliary device; and
updating the resource discovery list based on the device list, wherein the resource discovery list contains the device list.

4. The method according to claim 3, wherein the adding the second device type to the device list of the Internet of Things auxiliary device comprises:
generating second device information of the non-Internet-of-Things device, wherein the second device information comprises at least one of a device identifier, a device type, an interface type, an operation function set and port information; and
adding the second device information to the device list of the Internet of Things auxiliary device.

5. The method according to claim 4, wherein the generating the second device information of the non-Internet-of-Things device comprises at least one of the following:
generating a device identifier of the non-Internet-of-Things device, wherein the device identifier of the non-Internet-of-Things device is different from the device identifier of the Internet of Things auxiliary device;
generating an interface type of the non-Internet-of-Things device, wherein the interface type is used to indicate an access mode of a device interlace, and the interface type of the non-Internet-of-Things device is identical to an interface type of the Internet of Things auxiliary device;
generating an operation function set of the non-Internet-of-Things device, wherein the operation function set is a set of device support functions, and the operation function set of the non-Internet-of-Things device is identical to an operation function set of the Internet of Things auxiliary device, or, the operation function set of the non-Internet-of-Things device is a subset of the operation function set of the Internet of Things auxiliary device; and
generating port information of the non-Internet-of-Things device, wherein the port information of the non-Internet-of-Things device is identical to or different from port information of the Internet of Things auxiliary device.

6. The method according to claim 3, wherein the adding the second device type to the device list of the Internet of Things auxiliary device comprises:
determining the first device information of the Internet of Things auxiliary device as device information of the non-Internet-of-Things device; and
adding a target parameter to the device list of the Internet of Things auxiliary device, wherein the target parameter contains the second device type, and the target parameter is used to indicate that the Internet of Things auxiliary device is connected to the non-Internet-of-Things device.

7. The method according to claim 6, wherein the transmitting the device discovery response message to the control terminal comprises:
when the device discovery message does not contain a target device type, transmitting the device discovery response message containing the first device type and the target parameter to the control terminal.

8. The method according to claim 6, wherein the device discovery message contains a target device type, and after receiving the device discovery message transmitted by the control terminal, the method further comprises:
responding to the device discovery message when meeting at least one of the following conditions: the first device type matches the target device type and the second device type contained in the target parameter matches the target device type.

9. The method according to claim 1, wherein before receiving the device discovery message transmitted by the control terminal, the method further comprises:
receiving a second registration request transmitted by the control terminal, Wherein the second registration request contains a registration address and the second device type;
transmitting a third registration request to a server according to the registration address, wherein the third registration request contains the second device type and first device information of the Internet of Things auxiliary device;
receiving registration information transmitted by the server, wherein the registration information contains second device information of the non-Internet-of-Things device;
updating a resource discovery list according to the registration information; and
transmitting a registration complete notification to the control terminal.

10. A device discovery method applied to a control terminal, comprising:
transmitting a device discovery message; and
receiving a device discovery response message transmitted by Internet of Things auxiliary device, wherein the device discovery response message comprises a first device type and a second device type, the Internet of Things auxiliary device is connected to a non-Internet-of-Things device, the first device type is a device type of the Internet of Things auxiliary device, and the second device type is a device type of an Internet of Things device corresponding to the non-Internet-of-Things device.

11. The method according to claim 10, wherein before transmitting the device discovery message, the method further comprises:
transmitting a first registration request to the Internet of Things auxiliary device, wherein the first registration request contains the second device type of the non-Internet-of-Things device; and
receiving a registration complete notification transmitted by the Internet of Things auxiliary device.

12. The method according to claim 10, wherein before transmitting the device discovery message, the method further comprises:
transmitting a second registration request to the Internet of Things auxiliary device, wherein the second registration request contains the second device type and a registration address of the non-Internet-of-Things device, and the Internet of Things auxiliary device is used to transmit a third registration request to a server according to the registration address and acquire registration information; and
receiving a registration complete notification transmitted by the Internet of Things auxiliary device.

13. An Internet of Things auxiliary device, comprising: a processor, a receiver, and a transmitter;
wherein the processor is configured to control the receiver to receive a device discovery message transmitted by a control terminal; and
the processor is configured to control the transmitter to transmit a device discovery response message to the control terminal, the device discovery response message comprises a first device type and a second device type, the first device type is a device type of the Internet of Things auxiliary device, the second device type is a device type of an Internet of Things device corresponding to an non-Internet-of-Things device, and the Internet of Things auxiliary device is connected to the non-Internet-of-Things device.

14. A control terminal, comprising: a processor, a receiver, and a transmitter;
wherein the processor is configured to control the transmitter and receiver to implement the device discovery method according to claim 10.

15. An Internet of Things system, comprising: a control terminal, an Internet of Things auxiliary device and a non-Internet-of-Things device, wherein the Internet of Things auxiliary device is connected to the non-Internet-of-Things device;
the control terminal comprises the control terminal according to claim 14; and
the Internet of Things auxiliary device comprises the Internet of Things auxiliary device which comprises: a processor, a receiver, and a transmitter;
wherein the processor is configured to control the receiver to receive a device discovery message transmitted by a control terminal; and
the processor is configured to control the transmitter to transmit a device discovery response message to the control terminal, the device discovery response message comprises a first device type and a second device type, the first device type is a device type of the Internet of Things auxiliary device, the second device type is a device type of an Internet of Things device corresponding to a non-Internet-of-Things device, and the Internet of Things auxiliary device is connected to the non-Internet-of-Things device.

16. A computer-readable storage medium storing at least one instruction which is executed by a processor to implement the device discovery method according to claim 1.

17. A computer-readable storage medium storing at least one instruction which is executed by a processor to implement the device discovery method according to claim 2.

18. A computer-readable storage medium storing at least one instruction which is executed by a processor to implement the device discovery method according to claim 5.

19. A computer-readable storage medium storing at least one instruction which is executed by a processor to implement the device discovery method according to claim 9.

20. A computer-readable storage medium storing at least one instruction which is executed by a processor to implement the device discovery method according to claim 10.
